(19) United States
(12) Patent Application Publication
(10) Pub. No.: US 2006/0278444 A1
(43) Pub. Date: Dec. 14, 2006

(54) Touch technology

(76) Inventor: Ronald P. Binstead, Radford (GB)

Correspondence Address: C. ROBERT VON HELLENS;CAHILL, VON HELLENS & GLAZER P.L.C., 155 PARK ONE,, 2141 E. HIGHLAND AVENUE, PHOENIX, AZ, 85016, US

(21) Appl. No.: 10/560,701

(22) PCT Filed: Jun. 14, 2004
(86) PCT No.: PCT/GB04/02511

§ 371 Date: May 22, 2006

(30) Foreign Application Priority Data
Jun. 14, 2003 (GB) 0313808.8

(51) Int. Cl. G08C 21/00

(52) U.S. Cl. 178/18.06; 345/173

(57) ABSTRACT

A touchpad comprising a supporting medium (3) supporting a plurality of spaced apart conductors (2) in which there is no electrical contact between the conductors, each conductor being sensitive to the proximity of a finger (1) to vary the capacitance of said conductor (2) to detect the presence of said finger (1) positioned close to that conductor, the touchpad further comprising a means (4) to concentrate electric field between conductors (2) towards the plane of the supporting medium (3).

The present invention relates to touch detection, proximity detectors and touch sensitive surfaces and devices.

There are many known examples of devices which are able to detect the touch, or close proximity, of an object. Some are based on the use of membrane switches having two sets of conductors held in opposed relation, which require the exertion of pressure at an intersection of two conducting elements in order to form an electrical connection. Disadvantages of these devices are that the surface must actually be touched and the positioning of the user's finger must coincide with the conducting element intersection. Moreover, membrane switches include moving parts which are subject to wear and tear and therefore do not make robust sensing devices.

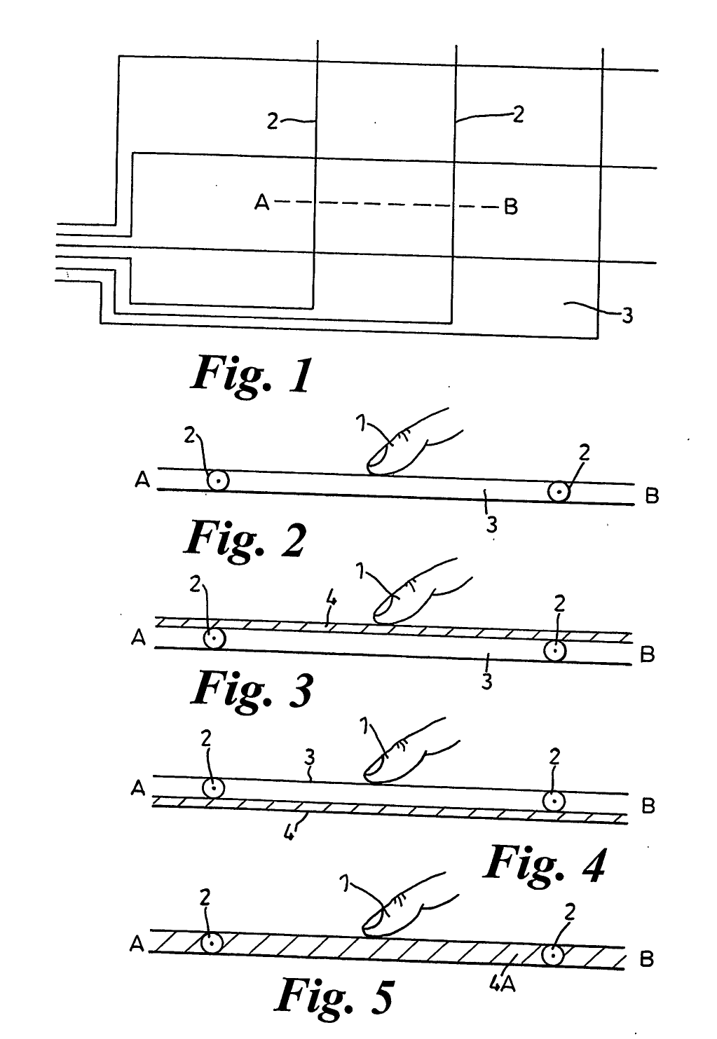

An alternative sensing device uses an array of proximity sensing conductors and relies upon variations in capacitance of the conductors to detect the exact position of a finger which is in contact with a sensing layer supporting the conductors, or in close proximity to the conductors. Such a sensing device is described in U.S. Pat. No. 6,137,427 awarded to Binstead, and is shown in FIG. 1, wherein an array of horizontal and vertical sensing conductors 2, which are electrically isolated from each other, are arranged into a grid structure and are supported by an electrically insulating membrane 3. The membrane 3 and array of conductors 2 form the sensing layer of a touchpad, as shown in FIG. 2 as a side cross sectional view along the line A-B of the device of FIG. 1. When a finger 1, or similar object, touches or comes close to the surface of the sensing layer, the finger induces a change in the capacitance of a conductor 2, or group of conductors, in the sensing layer. Using suitable scanning apparatus to scan each conductor 2 in turn, the variation in capacitance of a conductor 2 can be measured and therefore the touch, or proximity, of the finger 1 may be detected. By detecting changes in capacitance on more than one conductor 2, the exact position of the touch, or proximity, of the finger 1 may be determined by interpolating between the conductor positions. Hence, capacitive devices are able to detect the position of the finger 1 between sensing conductors 2, and therefore are not constrained to detection at intersections of conductors, unlike the aforementioned membrane switch devices.

However, a disadvantage of conventional capacitive devices is that difficulty arises when the sensing conductors 2 are widely spaced apart, since a touch, or close proximity, of a finger 1 between the conductors generally gives rise to only limited data values for the interpolation process, thereby leading to errors in calculating the exact position of the finger.

Moreover, conventional capacitive devices suffer from a further problem which occurs whenever a palm of a hand is held just above the device, since a palm induces a strong signal which can be falsely identified as a touching action. This can be particularly disadvantageous since a user must be continually aware of the position of their hands in relation to the device, while deciding upon their next true touching action.

It is to be understood that throughout the present specification, reference to ‘finger’ is intended to include any object capable of being used to locally modify the capacitance to an extent that detection is possible by way of capacitive sensing. Furthermore, any references to ‘touching’ or ‘touching action’ are to be taken to include both physical touching of a surface and the bringing of a finger into close proximity to a surface.

An object of the present invention is to solve at least some or all of the above problems.

The present invention is directed towards the construction of a touch detection system comprising a means to alter the immediate capacitive environment of the system. The means may be adapted so that variations in capacitance are propagated by high levels of capacitive coupling or adapted to allow the variations to propagate directly via electrical conductivity. Alternatively, the means may be adapted to support both of these electrical effects.

One aspect of the present invention is to provide a method of altering the immediate capactive environment of a subset of the first and second series of conductors of a capacitive touch detection system, to improve the accuracy and speed of touch detection of the system.

Another aspect of the present invention is to provide a mixture of resistive environments to control the pattern of touch detection in a proximity detection system.

Another aspect of the present invention is to provide a conductive and/or capacitively coupled medium to physically distort the detection environment of a proximity detection system.

According to a another aspect of the present invention there is provided a touchpad apparatus, comprising:
a supporting medium supporting a plurality of spaced apart conductors in which there is no electrical contact between the conductors, each conductor being sensitive to the proximity of a finger to modify the capacitance of said conductor to detect the presence of said finger positioned close to that conductor, the touchpad further comprising a means to concentrate electric field between conductors towards the plane of the supporting medium.

According to another aspect of the present invention there is provided a touchpad system including a touchpad according to the first aspect of the present invention, including:
a touch sensing and wake up circuit; and
a position sensing circuit which is normally asleep and periodically wakes to measure the state of the touchpad, where in response to a touch, the touch sensing circuit wakes up the position sensing circuit which then scans the surface to determine the touch position.

Embodiments of the present invention will now be described by way of example and with reference to the accompanying drawings in which:

FIG. 1 shows a top plan view of a sensing conductor arrangement for a touchpad.

FIG. 2 shows a conventional touchpad in side cross section on the line A-B through the touchpad layout of FIG. 1.

FIGS. 3 to 11 show alternative embodiments of the touchpad of the present invention in side cross-section on the line A-B through the touchpad layout of FIG. 1.

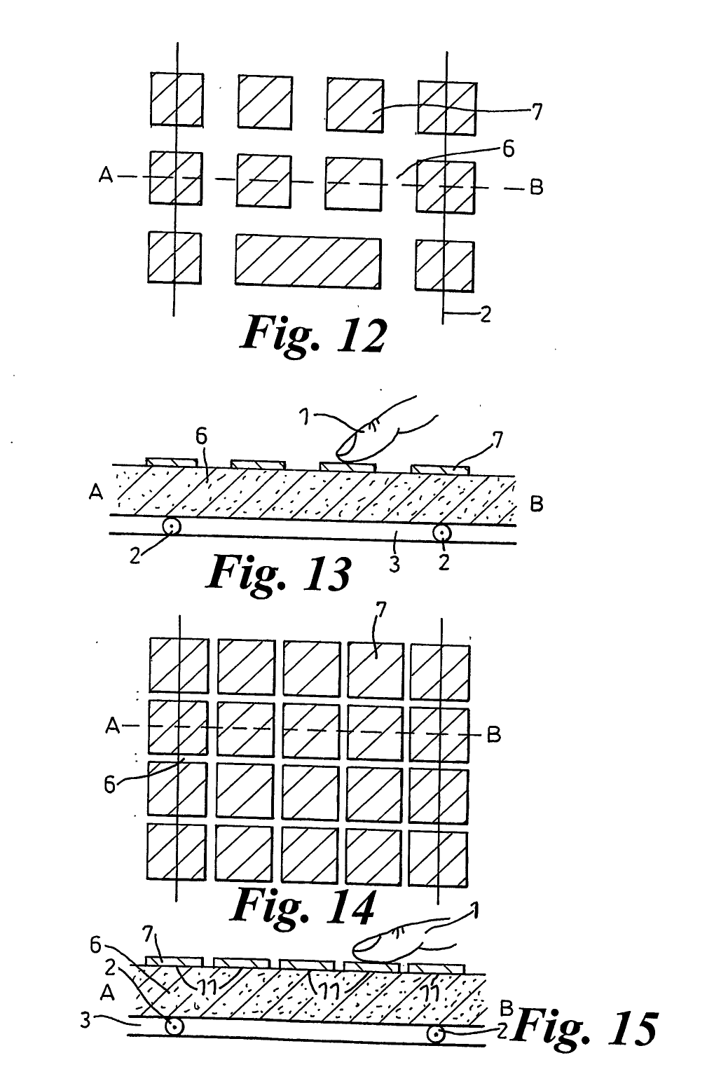

FIG. 12 shows a top plan view of an arrangement of electrically isolated conductive regions on the surface of a dielectric according to the present invention.

FIG. 13 shows a side cross-sectional view of the arrangement of FIG. 12 along the line defined by A-B.

FIG. 14 shows a top plan view of another arrangement of electrically isolated conductive regions on the surface of a dielectric according to the present invention.

FIG. 15 shows a side cross-sectional view of the arrangement of FIG. 14 along the line defined by A-B.

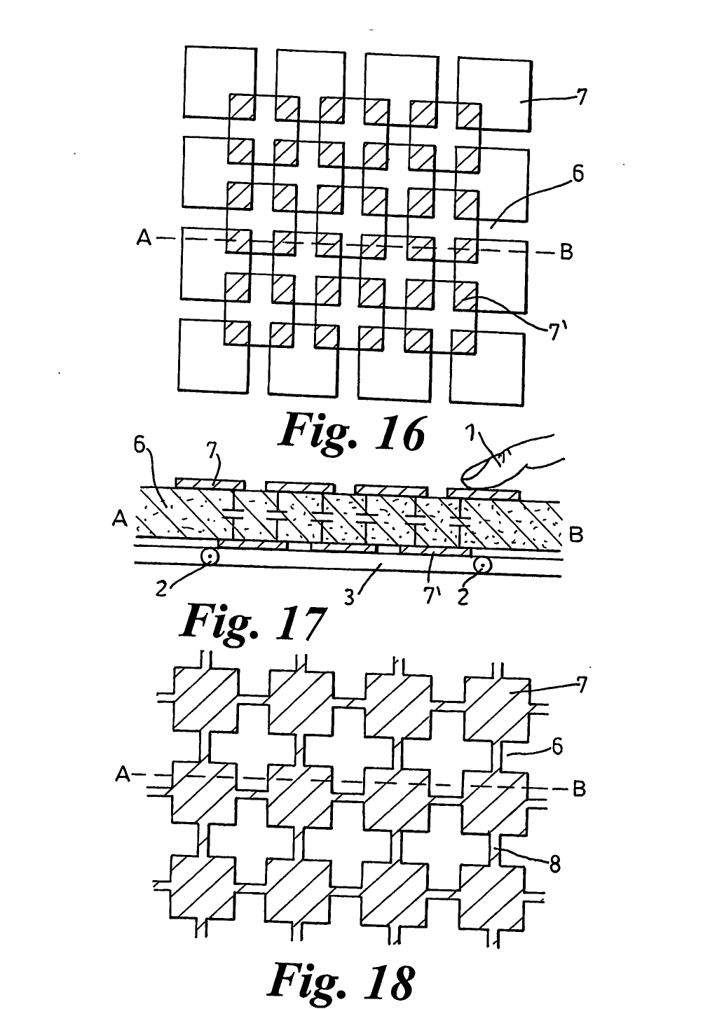

FIG. 16 shows a top plan view of a further arrangement of electrically isolated conductive regions on a first and a second surface of a dielectric according to the present invention.

FIG. 17 shows a side cross-sectional view of the arrangement of FIG. 16 along the line defined by A-B.

FIG. 18 shows a top plan view of a pattern of conductive regions connected by conductive bridges for use with the touchpad of the present invention.

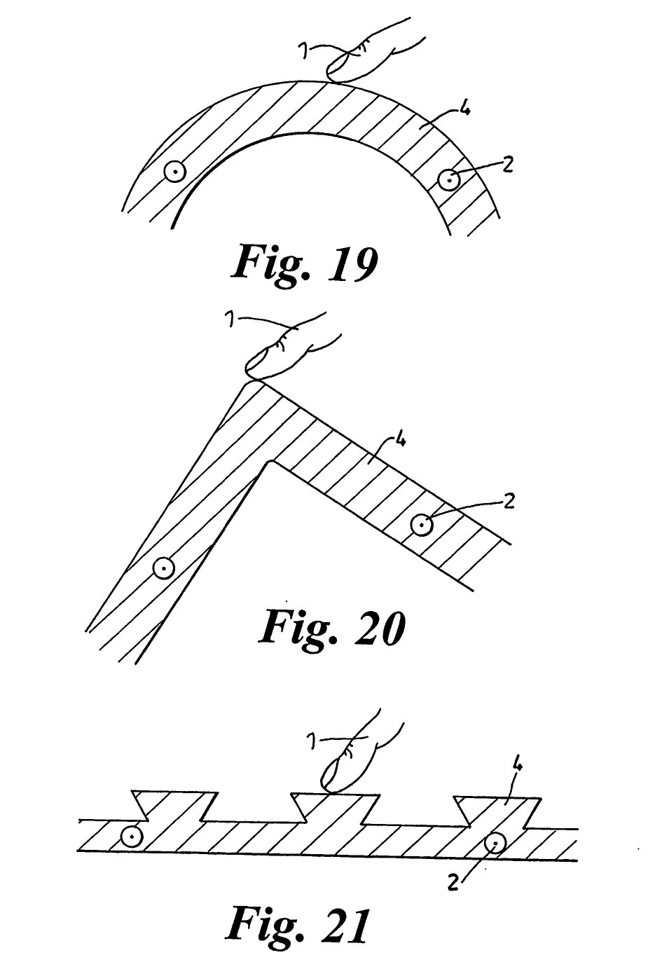

FIGS. 19 and 20 show side cross sections of arrangements of the touchpad according to embodiments of the present invention.

FIG. 21 shows a partial side cross-sectional view of a touchpad arrangement according to an embodiment of the present invention, showing a textured surface.

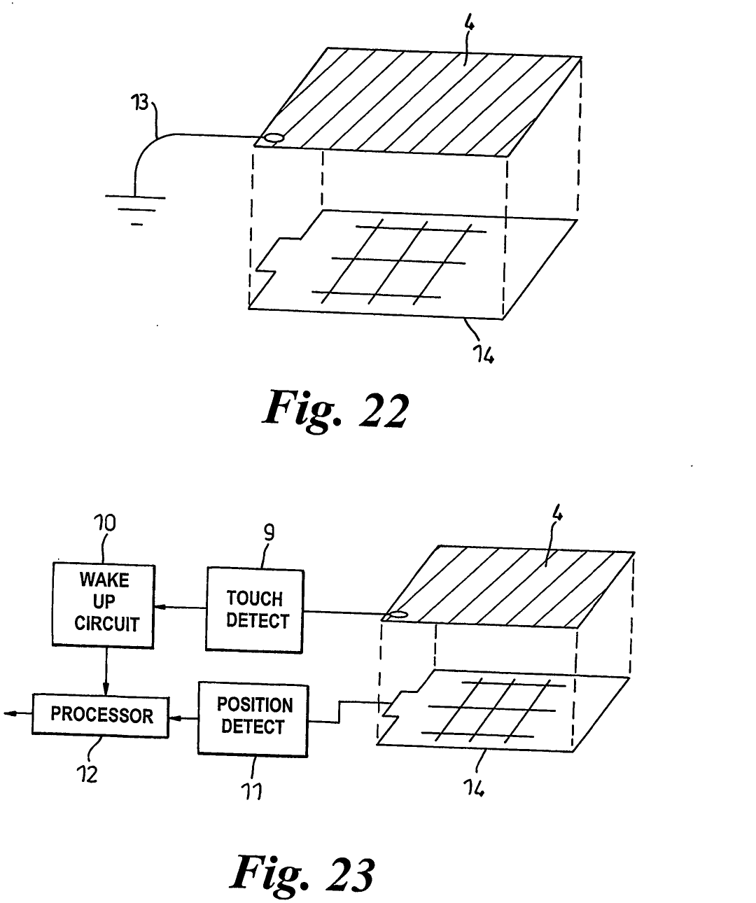

FIG. 22 shows a schematic illustration of the grounded conductive medium in a touchpad of the present invention.

FIG. 23 shows a schematic embodiment of a sensor system for use with the touchpad of the present invention.

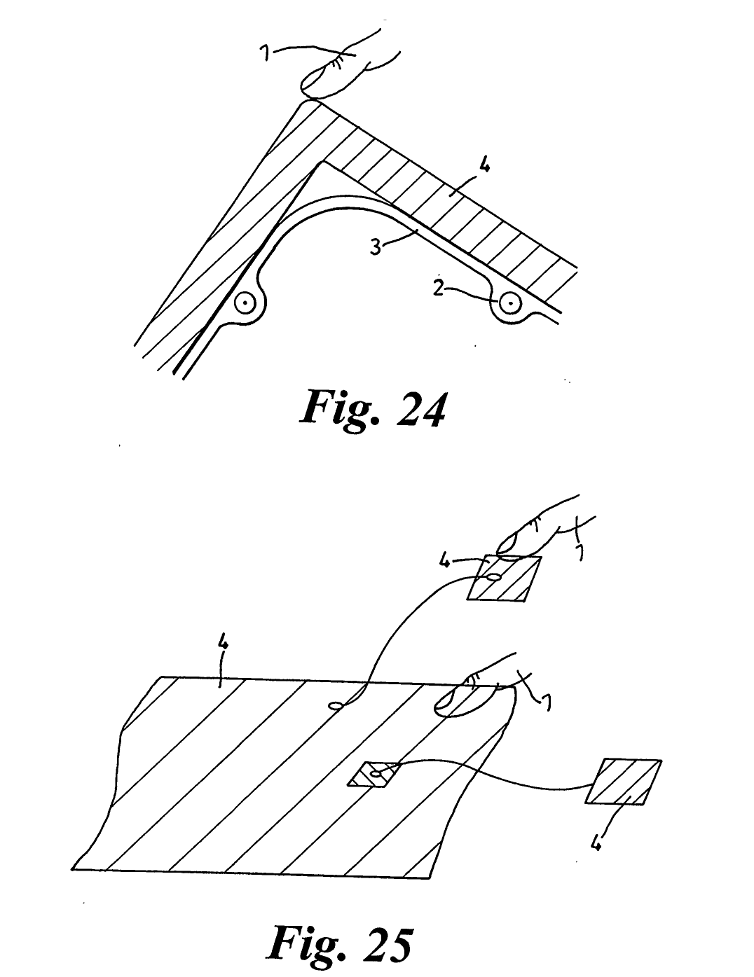

FIG. 24 shows a side cross-sectional view of a touchpad arrangement according to a further embodiment of the present invention, showing a spacing or gap in the touchpad.

FIG. 25 shows a perspective view of another arrangement of the touchpad according to an embodiment of the present invention.

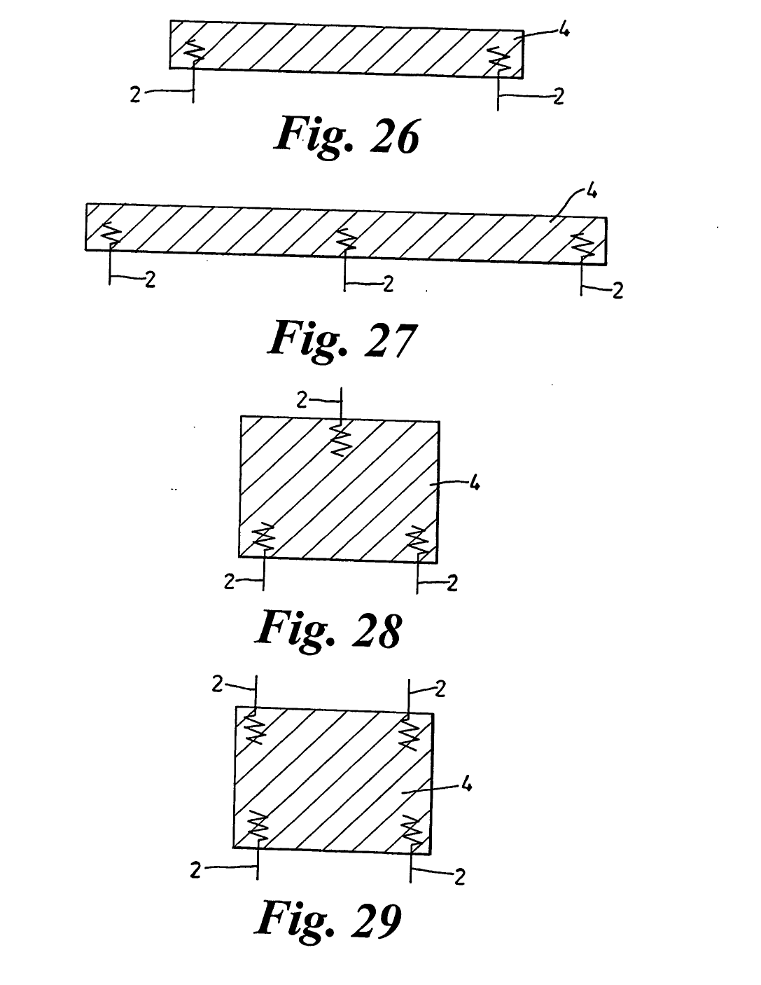

FIGS. 26 to 31 show top plan views of other touchpad arrangements according to embodiments of the present invention.

With reference to FIG. 3, there is shown one embodiment of a touchpad of the present invention. The touchpad is illustrated in side cross section along the line A-B of the touchpad layout of FIG. 1, and comprises an array of sensing conductors 2, a supporting medium, e.g. membrane 3 and a means 4 to concentrate electric field passing between the sensing conductors 2 towards the plane of the supporting membrane 3.

The sensing conductors 2 may be of a type as described in U.S. Pat. No. 6,137,427, and are arranged as a first and second series of parallel, spaced apart, conductors (as shown in FIG. 1), each conductor having appropriate connections at one or both ends, and each series being orthogonal, but not in electrical contact with each other. The first and second series of conductors 2 thus form a plurality of intersections. The conductors 2 are preferably conductive wires having a thickness dependent on the particular application of the touchpad. For example, in touch-screen applications, the wires are preferably substantially invisible to the eye and they may be less than 25 microns in diameter, or more particularly may be between about 10 microns to about 25 microns in diameter. In other applications, such as interactive masonry blocks, the wires may be reinforced steel rods of about 1 cm diameter. The wires may be made from copper, gold, tungsten, iron, carbon fibre or any other reasonably good conductor. The wires are preferably electrically insulated, for example, by coating the wires in an enamel or plastic sheath.

Alternatively in other embodiments, the first and second series of conductors 2 may be made from a material such as a silver-based conducting ink. If the conductors 2 are to be of low visibility where the touchpad is to be used in front of a suitable display system, then relatively wide (from about 250 micron to about 1000 micron) indium tin oxide traces may be used instead.

In further alternative embodiments, the first and second series of conductors 2 may also be in the form of copper tracks on a printed circuit board, or relatively fine aluminium or copper tracks in a TFT matrix.

It will be understood that the conductors 2 can be pre-formed (having their own structural integrity) prior to attachment to the supporting membrane 3, or they may be non-self-supporting conductors that are deposited onto the membrane for support.

It is to be appreciated that any suitable method of electrically insulating the conductors 2 from each of the other conductors, and their surrounding medium, may be used, including but not limited to, dielectric (e.g. plastic or thin glass) sheaths or localised dielectric sandwich layers (not shown).

In preferred embodiments, the thickness of the conductors 2 is small compared to the inter-conductor spacing of adjacent conductors in the same series, and the inter-conductor spacing need not be the same for each adjacent pair of conductors. In accordance with the present invention, the inter-conductor spacing for a wire of 10 micron diameter, for example, is preferably in the range of about 5 cm to about 10 cm, while in conventional touchpad arrangements the equivalent spacing would need to be about 1 cm. However, it is to be appreciated that the inter-conductor spacings are dependent on the particular application of the touchpad and therefore the example range is not intended to be limiting.

In other embodiments, the first and second series of conductors 2 need not be parallel, nor is it necessary for the first and second series of conductors to be mutually orthogonal.

In all embodiments of the present invention, the sensing conductors 2 are sensitive to the proximity of a finger 1 which modifies the capacitance environment of one or more of the conductors to thereby detect the presence of the finger 1.

The membrane 3 acts as a support medium for the first and second series of conductors 2 and is preferably made from an electrically insulating material e.g. a suitable dielectric. In preferred embodiments, the first and second series of conductors 2 are completely contained within the membrane 3, except for the appropriate end connections, which may preferably protrude from one or more sides of the membrane 3. These end connections are used to connect the sensing conductors to a suitable scanning apparatus.

The preferred thickness range of the membrane 3 is dependent on the particular application of the touchpad. For example, in a touch screen application, where the wires are typically embedded in a glass membrane, the thickness may be about 4 mm to about 12 mm. In keypad applications, the membrane may be about 1 mm thick. If the membrane is embedded in masonry blocks forming part of an interactive wall for instance, the membrane may be about 10 cm thick. However, it is to be understood that the thickness of the membrane 3 can be altered depending on the requirements (e.g. sensitivity and flexibility for instance) of the touchpad.

Throughout the present specification, the combination of the membrane 3 and sensing conductors 2 will be referred to as the ‘sensing layer’.

It is to be appreciated that the membrane 3 need not be limited to flat, or planar, configurations, and in fact, the membrane 3 may alternatively be arranged into non-planar, curved or angular configurations, in accordance with the present invention. Hence, any references herein to the “plane of the membrane” are to be taken to include both flat and non-planar configurations of the supporting medium, whereby the direction of the plane defined at a particular point along the surface of the membrane 3 corresponds substantially to the direction of a tangent at that point. Therefore, the plane of the membrane may be a surface contour tracing the shape of the membrane.

Referring again to FIG. 3, the means 4 to concentrate electric field between the sensing conductors 2 towards the plane of the membrane 3 is shown proximal to the first and second series of conductors 2. In preferred embodiments, the means 4 is an electrically conductive medium, which is configured to allow capacitive variations to propagate directly via the conductivity of the medium. In these embodiments, the conductive medium 4 preferably has a resistivity in the range 100 ohms per square to 10,000,000 ohms per square. The desired resistivity of the conductive medium depends on the inter-conductor spacing between the sensing conductors 2, since a wide spacing will require a lower resistivity medium to sufficiently accentuate the capacitive variation induced by a finger, in order to obtain a reliable interpolation of the finger's position.

In other preferred embodiments, the conductive medium 4 is configured to propagate capacitive variations via capacitive coupling, wherein the resistivity of the medium will be at least 1000 million ohms per square. In preferred embodiments, the conductive medium 4 is in the form of a conductive layer 4, which covers at least a portion of the membrane 3. The conductive layer 4 may cover the membrane 3 directly or indirectly and is electrically insulated from the sensing conductors 2 by virtue of the membrane material and/or the electrical insulation of the sensing conductors.

The conductive layer 4 has a preferred thickness in the range of about 25 microns to about 5 mm and is preferably about 1 mm to about 2 mm thick in a typical touchpad arrangement. However, it is to be appreciated that the thickness of the conductive layer 4 may be altered depending on the resistance required within the conductive layer 4, since thinner layers have a higher resistance as compared to thicker layers.

In preferred embodiments, the conductive layer 4 is deposited directly onto an outer surface of the membrane 3 and is supported thereon. The conductive layer 4 may be deposited by any conventional technique, including but not limited to, electroplating, sputter coating, painting, spraying and screen printing/ink-jet printing with conductive ink.

Alternatively, if the conductive layer 4 is formed as a separate laminate, the layer 4 may be bonded to the outer surface of the membrane using any suitable hardening or non-hardening conductive adhesive.

In other embodiments, the function of the supporting medium may be provided by the means for concentrating the electric field, in that the concentrating means may also act as a support for the sensing conductors. A particular example would be wires bonded to the concentrating means using a non-conductive adhesive tape, or non-conductive adhesive for instance.

In an aspect of the present invention, that the conductive layer 4 has resistive and capacitive properties which force the touch sensing of the sensing conductors 2 to be substantially aligned with the surface contour of the membrane 3. The conductive layer 4 distorts the capacitive field caused by the finger in a manner that causes touch sensing to be aligned substantially along the surface of the conductive layer, which in preferred embodiments traces the surface contour of the membrane 3.

Referring once again to FIG. 3, the presence of the conductive layer 4 acts to concentrate the electric field between the sensing conductors 2, towards the plane of the membrane 3, so that when a finger 1 touches, or comes very close to the conductive layer 4, the finger induces a change in capacitance of about 0.5% to about 5% above the existing capacitive value. This change in capacitance is readily detectable by the sensing conductors 2 as a strong capacitive signal which is accentuated by the conductive layer 4.

The induced signal is significantly larger due to the presence of the conductive layer, than would be produced in the absence of such a layer, due to the concentration of the sensing conductor electric fields towards the membrane 3. The capacitive signal spreads radially away from the point of touch with a strength that decreases with increasing distance from the touch point. In embodiments in which the conductive layer 4 is configured to propagate capacitive variations directly via the conductivity of the layer, the rate of capacitive signal attenuation is found to be related to the resistance of the layer, such that highly conductive (low resistance) layers spread the signal over a wider area of the layer, as opposed to low conductivity (high resistance) layers which spread the signal over a much smaller area. If the conductive layer 4 is uniform in thickness and spatial extent, the capacitive signal will spread out evenly in all directions from the touch point.

Any variations in resistance across the conducting layer 4 have an effect on the linearity of the signal spread. However, relatively small variations in resistance produce virtually undetectable effects in the signal spread, since the operational resistance range is so comparatively large.

In some embodiments, however, it is advantageous to have portions of the conductive layer 4 with increased conductivity, as compared to other lower conductivity portions, in order to exert some degree of control over how the capacitive signal is spread. The variations in conductivity may preferably be achieved by altering the chemical composition of the conductive layer 4, by having variations in the thickness of the layer, or by using a combination of these techniques.

The conductive layer 4 may comprise portions of different conductivity, including portions of no conductivity (i.e. portions having a resistance so high that they are essentially electrically insulating), low conductivity, medium conductivity and high conductivity.

It is preferred that the conductive layer 4 has a resistivity less than 100,000,000 ohms per square, or more preferably, less than 10,000,000 ohms per square. Otherwise, any induced capacitive signal may be so heavily attenuated that any advantages in signal detection are substantially reduced.

In preferred embodiments, the conductive layer 4 may be touched directly, as shown in the embodiment of FIG. 3. The sensitivity of the touchpad in this arrangement is sufficiently high to allow a user to perform touching actions whilst wearing thin gloves, which can be advantageous if the device is to be used in environments which require the user to have some form of hand protection e.g. in chemical laboratories or surgical theatres, or if it is desired to keep the device grease and dirt free.

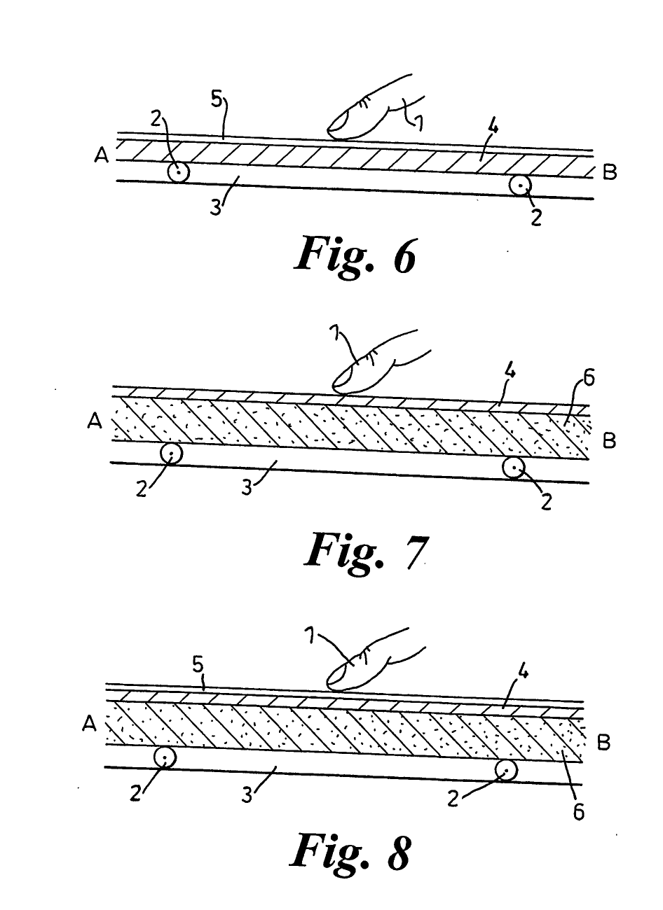

In other preferred embodiments, the touchpad may include a non-conductive layer 5 proximate to the conductive layer 4. Preferably, the non-conductive layer 5 is in the form of a thin coating which is deposited onto the conductive layer 4 as shown in FIG. 6, which prevents direct user contact with the conductive layer 4. This can be used to protect the conductive layer 4 from damage and/or provide an anti-reflective finish to the device. The non-conducting layer may also be purely decorative, or in the case of the device being used as a keypad for instance, the layer may be printed with icons or symbols, indicating the position of keys etc. In this arrangement, a finger 1 touches the non-conductive layer 5 and induces a variation in capacitance which is spread by the conductive layer 4, and is thereby detected by the underlying sensing conductors 2.

In other embodiments, the conductive layer 4 may be deposited on the underside of the membrane 3, as shown in FIG. 4, and a finger 1 may be brought into contact, or proximity, with the side of the membrane 3 opposite to the conductive layer 4. In this arrangement, the conductive layer 4 is still operable to alter the capacitive environment of the sensing conductors 2, by concentrating the electric field passing therebetween towards the membrane 3, so that a touching action or proximity of a finger 1 can be detected on, or near to, the membrane surface. However, since the conductive layer 4 is not touched directly, the induced capacitive signal is not as strong as in the previous embodiment.

The embodiment of FIG. 4 can be advantageous, since the conductive layer 4 is protected from direct contact with a user's finger 1 and therefore is not susceptible to damage and/or wear and tear during normal use.

In an alternative embodiment, the membrane 3 and conductive medium 4 may be combined into a single conductive support and sensing layer 4A, as shown in FIG. 5. In this arrangement the support and sensing layer 4A is preferably formed from a bulk doped medium having a bulk conductivity, which gives rise to a very strong capacitive signal at the time of a touching action. Preferably, the bulk doped medium is glass or plastic, comprising a dopant of conductive material.

Conventional clear conductive plastics have a very high resistance, typically 1,000,000,000 ohms per square, but this may be reduced by adding small quantities of conductive particles, platelets or fibres to the plastic. These particles or fibres are generally not transparent, but may be selected to be preferably sufficiently small so as to not be visible. The particles may be metal such as copper, gold and silver for instance, or may be a metal oxide. Alternatively, graphite or other conductive substances, can be used. If it is intended for these particles to remain invisible to the eye, then the particles are typically about 10 microns wide, or less. The fibres may be carbon fibres or nanotubes. These fibres may be short (up to about 10 mm in length) and randomly oriented throughout the plastic. Alternatively, the fibres may be longer and can be loosely woven into a sheet and then encased in the plastic.

It is to be appreciated that non-conductive plastics can also be doped with conductive material, in the same manner, in order to produce a medium with a bulk conductivity, or altered capacitive coupling.

By selecting the required amount of particulate and/or fibrous dopant, a conductive plastic sheet can be fabricated with the required range of resistivity, in which the particles and fibres within the plastic are electrically or capacitively linked by the supporting matrix of the plastic.

The doped plastics can be shaped using any conventional technique, such as, but not limited to, lamination, vacuum forming and injection moulding.

In the embodiment as shown in FIG. 5, the sensing conductors 2 are preferably completely contained within the support and sensing layer 4A. However, since the conductors 2 are preferably electrically insulated, short circuiting of the conductors 2, due to the bulk conductivity of the layer, is prevented.

The support and sensing layer 4A may be touched directly, as shown in FIG. 5, and the induced variation in capacitance of the conductors 2 is propagated as a capacitive signal throughout the layer. In this arrangement a large capacitive signal is induced by virtue of the conductors 2 residing within the support and sensing layer 4A. The spread of the capacitive signal can be controlled by pre-selecting the resistivity, or internal capacitive coupling, of the doped medium, since a highly doped medium will have an intrinsic high conductivity, which will propagate the signal throughout a larger volume of the layer, as compared to a weakly doped medium which will propagate the signal throughout a comparatively smaller volume of the layer.

Herein, throughout the specification use of the term ‘proximal’ is to be taken to include arrangements in which the conductive medium 4 resides in one or more conductive layers 4 which are separate from the sensing layer and arrangements in which the conductive medium 4 is a material component of the combined support and sensing layer 4A in which the sensing conductors 2 are disposed.

Referring to FIGS. 7 to 11, there are shown other preferred embodiments of a touchpad according to the present invention. In FIG. 7 there is shown a touchpad including a dielectric medium 6 which is arranged so as to separate the membrane 3 and conductive layer 4. The dielectric medium 6 is made from any suitable non-conductive medium, such as, but not limited to, plastic or glass and has a thickness which is relatively large as compared to the thickness of the conductive layer. The preferred thickness range of the dielectric medium is dependent on the particular application of the touchpad. For example, an epos machine may have a glass thickness of about 3 mm to about 4 mm, while an ATM machine may have about 12 mm of glass. If the touchpad is operated through the case of a portable computing device (e.g. a laptop computer etc.), the dielectric (i.e. case thickness) is about 1.5 mm.

Advantages of a dielectric medium 6 include increased support and strength for the touchpad structure and enhanced capacitive coupling for the conductive layer 4.

In preferred embodiments, the conductive layer 4 may be deposited directly onto an outer surface of the dielectric medium 6, using any conventional technique, such as, but not limited to, electro-plating, sputter coating, painting, spraying and screen printing/ink-jet printing with conductive ink and thereby be supported thereon.

Alternatively, if the conductive layer 4 is formed as a separate laminate, the layer 4 may be bonded to the outer surface of the dielectric medium using any suitable hardening or non-hardening conductive adhesive.

As shown in FIG. 7, a user may touch the conductive layer 4 which is supported by the dielectric medium 6, to thereby induce a variation in the capacitance of the sensing conductors 2 in the membrane 3.

In another embodiment, as shown in FIG. 8, the arrangement as shown in FIG. 7 may include a thin non-conducting layer 5, to protect the conductive layer 4 from damage and/or wear and tear etc.

In one example, the touchpad may form part of a back projection touch screen attached to a shop window, the window acting as a non-conducting layer 5. In this example the shop window may have a thickness of about 12 mm of glass, or about 25 mm, if double glazed. The touch screen would preferably include a 75 micron drafting film-type polyester screen, bonded to the outside of the glass with about 25 microns of a hardening or non-hardening conductive adhesive. The top layer of the polyester screen acts as a display screen and touch surface.

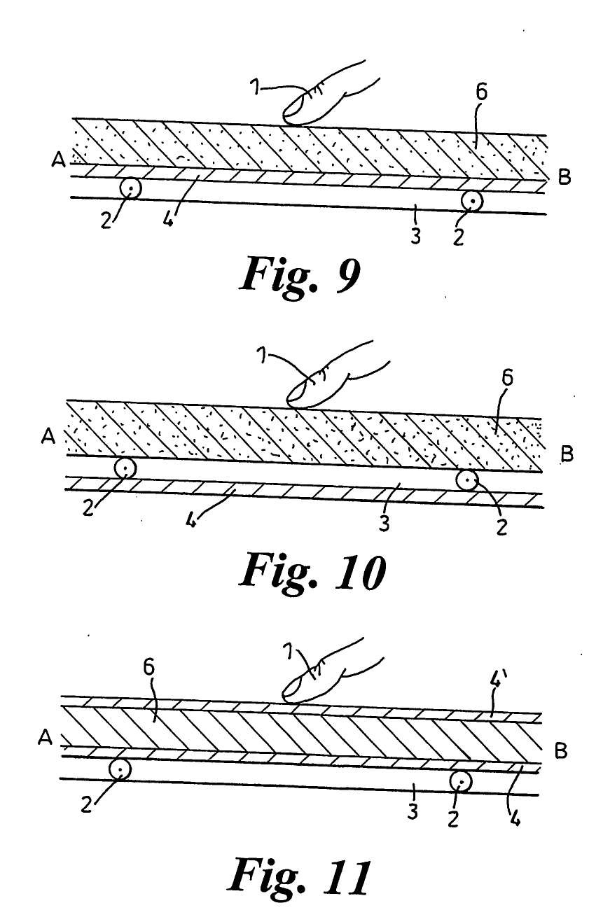

In a further embodiment, the conductive layer 4 may preferably be sandwiched between the membrane 3 and the dielectric medium 6 as shown in FIG. 9. In this arrangement, the conductive layer 4 is protected from damage by the dielectric medium 6, which may also add additional strength and support to the touchpad structure. The user may touch the dielectric medium 6 directly so as to induce a variation in the capacitance of one or more underlying sensing conductors 2, the variation being enhanced by the presence of the sandwiched conductive layer 4.

In a further embodiment, the membrane may preferably be sandwiched between the conductive layer 4 and the dielectric medium 6, as shown in FIG. 10.

In an alternative preferred embodiment, a further conductive layer 4′ may be included in the touchpad, as shown in FIG. 11. The further conductive layer 4′ is proximate to the dielectric medium, and is preferably deposited, using conventional techniques, onto the outer surface of the dielectric medium 6 which has an inner surface in contact with the original conductive layer 4, thereby sandwiching the dielectric between two conductive layers 4, 4′. The presence of the further conductive layer 4′ concentrates the electric field of the sensing conductors 2 on the opposing side of the dielectric medium 6, towards the medium and consequently provides a very strong capacitive coupling through the dielectric, giving a very rapid response to touching actions by the sensing conductors 2. The further conductive layer 4′ may preferably be formed from the same material as the original conductive layer 4, or alternatively is formed from any suitable conductive material.

It is to be appreciated that the embodiments described in relation to FIGS. 3 to 11 are preferred arrangements of the touchpad of the present invention, and in fact, any number, and combination, of conductive layers and/or dielectric media could be used to produce a touchpad according to the present invention. Therefore, the stratification of the layers and media is not intended to be limiting.

One particular use of the touchpad of the present invention is as a touchscreen for data display and entry. However, this places a constraint on the material that may be used for the conductive medium 4, since the sensing layer and conductive layer 4 need to be transparent, so that a background display system is visible to the user.

Preferably, a transparent conductive material such as Indium Tin Oxide (ITO) or Antimony Tin Oxide (ATO) may be used, which can be deposited onto a surface of the membrane 3 or dielectric 6 in accordance with any of the embodiments as described in relation to FIGS. 3 to 11. A disadvantage of these oxide materials however, is that they are typically manufactured with a resistivity which is outside the resistivity range of materials for use with this invention. The oxides typically have a resistivity of 10 ohms per square, which gives a conductive layer 4 a conductivity which is so large that any induced capacitive signal is spread across too wide an area, thereby preventing exact determination of the position of a touch point.

To overcome this problem, the conductive layer 4 comprising either ITO or ATO, may preferably be partially etched away or deposited as an incomplete layer by the use of conventional mask techniques. Hence, the conductive layer 4 may preferably be discontinuous.

In preferred embodiments, the ITO, or ATO, material may be configured into a plurality of electrically isolated conductive ‘islands’ or regions 7. These conductive regions 7 are separated by regions 6 of an outer surface of the membrane 3 or dielectric medium 6, depending upon which surface is supporting the conductive layer 4. The conductive regions 7 may be arranged in a regular pattern, or else can be randomly disposed, depending on the particular application of the touchpad. However, it is to be appreciated that it is not necessary to arrange the regions in strict accordance with the underlying pattern of sensing conductors 2, in order for the present invention to work.

Each conductive region 7 acts to concentrate the electric field of the sensing conductors 2 in the vicinity of that conductive region, thereby accentuating the variation in capacitance resulting from the proximity of a finger close to the region.

If the touchpad is to be used as a keypad, the conductive regions 7 may preferably be arranged so as to be coterminous with the site of a corresponding key. The size and shape of the conductive regions 7, may preferably be selected so as to be substantially similar to the size and shape of the key size.

Such an arrangement is shown in FIG. 12, in which the conductive regions 7 are arranged in the form of a stylised keypad, having separations between the conductive regions which have been selected to be comparable to the width of the conductive regions 7 themselves i.e. they are widely spaced apart.

In this arrangement, when a finger 1 touches one of the conductive regions 7, the variation in capacitance is sensed through the dielectric medium 6 by the sensing layer. However, use of such conductive regions 7 eliminates the possibility of determining exact positions of the touch points, but instead provide strong quantised signals when touched, allowing a suitable scanning apparatus to easily determine which conductive region 7 was touched and at what time. This effect allows a discontinuous conductive layer 4 to be used as a co-ordinate position indicator.

However, in order to achieve a strong capacitive coupling between adjacent conductive regions 7, the separations between the conductive regions 7 should be made as small as possible without short circuiting occurring between adjacent conductive regions 7. The size of the conductive regions 7 is determined by the resolution required in the touchpad, and is preferably about half of the resolution. For example, if a resolution of 5 mm is required, then the conductive regions should be about 3 mm by 3 mm (i.e. for a square region) with a spacing of about 100 microns between adjacent regions. In this arrangement, conduction between adjacent conductive regions 7 is not possible, and therefore the conductive layer 4 as a whole does not act as a conductive medium per se, instead the conductive regions are coupled by very strong capacitive coupling. The resistivity of the conductive layer 4, as a whole, in this arrangement will be of the order of thousands of millions of ohms per square. In the preferred embodiment of FIG. 14, the conductive regions 7 are closely arranged and as illustrated in FIG. 15, adjacent conductive regions 7 are capacitively coupled, thereby enabling any induced capacitive signal to be dispersed to adjacent neighbours surrounding the touch point. The adjacent capacitive coupling increases the capacitive signal and assists in dispersing the signal. The capacitive signal spreads through the dielectric 6 and induces a corresponding variation in the capacitive environment of the underlying sensing conductors 2 in the sensing layer.

This effect can be improved by using two conductive layers 4, 4′ as described in relation to the embodiment as shown in FIG. 11. In this embodiment, as shown in FIGS. 16 and 17, both of the conductive layers are discontinuous, with each having a plurality of electrically isolated conductive regions 7, 7′, such as formed by deposition of ITO or ATO transparent oxides for instance. Preferably, the further conductive layer is supported by a substantially opposing surface of the dielectric medium 6, thereby sandwiching the further conductive layer between the dielectric medium 6 and the sensing layer. The conductive regions 7′ of the further conductive layer are separated by regions of the opposing surface of the dielectric medium 6.

Preferably, the conductive regions 7 of the conductive layer and the conductive regions 7′ of the further conductive layer are configured so as to be substantially coterminous i.e. both layers comprise the same grid patterns which are substantially aligned.

Alternatively, the conductive regions 7 of the conductive layer and the conductive regions 7′ of the further conductive layer are configured so as to be substantially overlapping and non-coterminous i.e. both layers comprise the same keypad patterns but have a substantially translated alignment. This arrangement is shown in the embodiment of FIGS. 16 and 17, where adjacent and overlapping conductive regions 7, 7′, on either side of the dielectric medium 6, are strongly capacitively coupled through the dielectric, thereby accentuating the strength of the capacitive signal induced by a touch.

Herein the mapping of the areas of corresponding conductive regions 7, 7′ between the two conductive layers is referred to as ‘registering’.

It is to be appreciated that although the preferred embodiments, as exemplified by FIGS. 12 to 17, show stylised keypads comprising rectangular conductive regions 7, 7′, this is not meant to be limiting and therefore any suitable geometric shape may be used as a template for the shape of the region e.g. circular, triangular, trapezoidal or hexagonal etc.

In alternative embodiments, the resistance of an ITO layer, as a whole, may preferably be increased from the intrinsically low, 10 ohms per square, to the required range of values by uniformly etching away much of the thickness of the deposited conductive layer, to produce a thinner, more resistive layer. For example, if 99% of the layer thickness is etched away, a 10 ohms per square layer will become a 1000 ohms per square layer.

Alternatively, portions of the conductive layer 4 may preferably be completely etched away to leave a plurality of conductive regions linked by thin bridges 8 of remaining ITO material for instance, as shown in FIG. 18. Preferably, the conductive regions 7 have a relatively large width as compared to the width of the conductive bridges 8. The resistance of the etched conductive layer may further be preferably increased by etching away the thickness of the conductive bridges 8 as compared to the thickness of the conductive regions 7.

It is to be appreciated that although the above embodiments describe the use of ITO material, other conductive materials, having differing degrees of transparency, may be used in a similar fashion.

Referring to FIGS. 19 and 20, there are shown two embodiments of the touchpad of the present invention, in which the touchpad is preferably arranged into non-planar configurations, e.g. curves, domes or orthogonal structures. Instead of substantially linear interpolation between the sensing conductors 2, as in the previous embodiments, a non-planar conductive layer 4 causes the interpolation to be performed on the basis of the shape, or surface contour, of the layer 4. This provides the advantage that regions which otherwise would not be responsive to touch, such as corners of boxes or other pointed extremities, may now act as sensing regions, since the layer acts to concentrate the electric field passing between the sensing conductors 2 in the region of the extremities towards the membrane 3. In a non-planar touchpad configuration, the interpolation will be performed substantially aligned with the surface contour of the conductive layer 4. Advantageously, since the interpolation is performed across the surface contour of the conductive layer 4, the conductive layer 4 need not be in contact with the membrane 3, or dielectric medium 6, in the region of the extremity, such that small air gaps or spacings etc. (as shown in FIG. 24), do not significantly effect determination of the touch position.

The touchpad may be formed into complex 2 and 3 dimensional shapes, using any conventional technique, including, but not limited to, vacuum forming and injection moulding. The touchpad may be resilient or deformable, and depending on the materials used, may have any degree of required flexibility.

Thus it is possible with the present invention to produce many different 2D and 3D touch interactive materials and products. For example, the present invention could be used to produce mobile phones with the injection moulded case itself being touch interactive, so there would be no need for a separate keypad and/or touchscreen to be added. For these applications, the conductive medium 4 may be opaque, thus allowing the use of many more conductive materials, including materials having both surface and/or bulk conductivity.

Touch sensitive and non-touch sensitive areas can exist in the same injection moulding by zoning the sensing conductors 2 and having conducting and non-conducting clear and opaque plastics in the same injection moulding. By doing so, the front, back, sides, top, bottom, and all edges and corners could be made to be touch sensitive. Surfaces may be touchscreens, keypads, digitising tablets, trackerballs or change functionality from one to the other, when, and as required.

In alternative embodiments, the conductive layer 4 may be a conductive fabric, conductive rubber, conductive foam, an electrolyte (e.g. sea water), a conductive liquid or gel, or even a conductive gas, such as a plasma. However, it is to be appreciated that several of these materials would require some form of containment means, such as an outer membrane in order to maintain their position and to provide protection for the material. Conductive media that distort, or change resistance, when touched have the added advantage that the induced capacitive signal increases more strongly than compared to non-distorting media, when pressure is applied, allowing greater pressure sensing resolution. This may be advantageous in touchpad applications that require different pressures to be exerted to operate a particular function, such as an accelerator button. A disadvantage however, is that materials which resiliently distort typically have reduced operating lifetimes. In practice, the finger tip itself distorts when greater pressure is applied, and this can be detected by the touchpad without the material itself having to distort.

If a conductive support and sensing layer 4A is formed, as described in relation to FIG. 5, into a non-planar configuration as shown in FIG. 19, the layer deforms the capacitance detection system and allows the finger 1 to be detected at a point that would not be possible if a purely dielectric system, as described in U.S. Pat. No. 6,137,247 was used. As shown in FIG. 20, edges and corners of a non-planar touchpad are still operable to detect a touching action, even though the sensing conductors 2 are relatively remote from the point of touch.

The surface of the touchpad may preferably be flat and/or curved and/or have surface texturisation, such as dimples, grooves or hollows etc. as shown in FIG. 21. Surface distortions allow the point of touch to be redirected, while still being accurately detected by the sensing layer. The dimples shown in FIG. 21, can extend some distance away from the conductive layer 4, for example by about 1 m or more. The tip of the dimples may be connected back to the conductive layer 4 by any suitable conductor e.g. an electrical wire (as shown in FIG. 25). Touching the tip of the dimples would have the same effect as touching the conductive layer 4, at the point where the wire is joined to the layer 4. The wire may be electrically, or capacitively, linked to the conductive layer 4.

In preferred embodiments, the conductive medium 4 may electrically float, in that it has no electrical connection to the sensing conductors 2 or to any suitable scanning apparatus. Alternatively, the conductive medium may be connected to ground, either directly by an electrical connection 13 e.g. a wire, or by a resistor, as shown in FIG. 22, thus enabling the conductive medium 4 to perform the secondary function of an anti-static and emi shielding surface.

A suitable scanning apparatus for use with the touchpad of the present invention is described in EP 0185671 and in particular in U.S. Pat. No. 6,137,427. The scanning apparatus samples each conductor of the first and second series of sensing conductors 2 in turn, according to an analogue multiplexer sequence, and stores each capacitance value in memory. These values are compared with reference values from earlier scans, and with other capacitance values in the same scan from the other conductors in order to detect a touching event. The touching event must be above a threshold value in order to be valid. By having several threshold values it is possible to determine the pressure of the touch or distance that the finger 1 is away from the surface of the touchpad.

If a battery or solar cells are used, there may be no available ground connection, and so the conductive medium 4 may be connected to the 0 volts line of the scanning apparatus, or in fact, to the positive line since the touchpad is floating. The scanning apparatus described in U.S. Pat. No. 6,137,427 relies on there being a reference ground to determine when it has been touched. Battery operated systems have no real ground and rely on the bulk of the system to act as a ground. This situation is improved if there is available nearby, some form of metalwork to act as a grounding means. Connecting the conductive medium 4 to the 0 volts line acts as a substitute for the metalwork. Its effectiveness is greatly improved if the touchpad user is touching, or in close, proximity to the conductive medium, as the user acts as the ground reference. For example, if the whole case of a mobile phone were made of a conductive medium, the act of the holding the phone would serve as a very effective ground. All surfaces, edges and corners of a mobile phone could, in fact, be made touch-interactive, and any parts intended to be held by the hand of a user could be de-activated as a keypad but used instead as a reference ground. When the hand is removed, that part would be re-activated. The scanning apparatus of U.S. Pat. No. 6,137,427 continually adjusts to environmental conditions and could therefore be modified for use in the mobile phone application.

In some preferred embodiments, the conductive medium 4 may be larger than the membrane 3 and can wrap around the membrane 3 to cover at least a portion of the reverse side of the membrane 3. The conductive medium 4 may also act as a reference ground.

The remaining features of the scanning mechanism are well described in the cited documents and will not be discussed further here.

In a preferred embodiment, the touchpad of the present invention may be connected to a sensing circuit, which is used to indicate the exact time the touchpad is touched. The sensing circuit may, induce a voltage, or varying voltage on the conductive layer 4. The combination of the touchpad and sensing circuit enables a very rapid touch detection, which is considerably faster than the prior art systems. In the present invention, the time of a touch may be detected within about 2 to about 3 microseconds as opposed to about 10 milliseconds in the touch detection system of U.S. Pat. No. 6,137,427. This amounts to about a 1000 times increase in detection response time, since the U.S. Pat. No. 6,137,427 apparatus undertakes a complete scan of the touchpad before determining if a touching action has occurred. The scanning apparatus of U.S. Pat. No. 6,137,427 would, however, be needed determine the exact position of a touch.

Preferably, the sensing circuit comprises a touch detector circuit 9 and a wake up circuit 10, as shown in FIG. 23, with the sensing circuit normally ‘sleeping’ (i.e. in a stand-by mode) and periodically waking to measure the state of the touchpad. The touch detector circuit 9 would preferably be connected to the conductive layer 4. In response to a touching action, the touch detector circuit 9 signals the wake up circuit 10, which wakes up the sensing circuit, if in sleep mode, which then scans the surface, via a processor 12 and position detect circuit 11, to determine the touch position. The sensing circuit preferably consumes about 2 milliamps when awake, and about 10 microamps when normally sleeping. Hence, a 100 fold decrease in power requirement is potentially possible with a 1000 fold increase in response time. The sensing circuit can therefore be powered by a solar cell or by a small battery for instance.

Conductive earthed/grounded or active backplanes (not shown) may preferably be incorporated in the touchpad of the present invention. An insulated layer may be required between the conductive layer and any such backplane, in order to prevent short circuiting between the two.

Backplanes have to be connected to ground, or an active backplane driver, and generally need to have a very low resistance as compared to the preferred range of resistances of the conductive layer 4 in the touchpad of the present invention. An anti-static shield needs to be connected to Earth, otherwise it is found to accumulate charge, which diminishes its function as an anti-static shield. In order to operate correctly, anti-static shields need to have a very high resistance as compared to the preferred range of resistances of the conductive layer 4 in the touchpad of the present invention.

A further application of the present invention is as a solid state touch-interactive sheet, that can be touched independently on both sides. This sheet could preferably comprise a grounded or active backplane sandwiched between a pair of conductive layers.

A number of independent touch systems could also exist on a single surface, and could be used to create a substantially flat shop counter, having a plurality of epos machines configured within the single surface. To avoid any possible interference between adjacent machines, earthed or grounded backplanes may preferably be incorporated between each machine.

If a suitable doped plastic is used, such as the one described in relation to the embodiment of FIG. 5, the conductive support and sensing layer 4A may preferably be additionally used as a resonant surface for a speaker. This functionality would be temporarily suspended, while the surface was being touched e.g. while operating as a touchpad, but would be resumed following completion of the touching action, thereby once more generating sounds. A suitable speaker driver technology for this application would be a NXT system.

In addition, the conductive support and sensing layer 4A may be used as a microphone, for example, using a reverse NXT system.

In a further embodiment of the touchpad of the present invention, a thin, flexible display layer could be included as a layer in the touchpad. This would provide a complete, touch-interactive, display system. Suitable technologies for the display layer include, but are not limited to, e-ink, oled (organic light emitting displays) and leps (light emitting polymers).

Other applications of the touchpad of the present invention include a simple slide mechanism, wherein two sensing conductors are capacitively linked by a conductive layer in the form of a track (as shown in FIG. 26), in which the user runs his finger forwards and backwards along the track mimicking the action of a slide switch. The track is preferably about 10 cm in length by about 1 cm in width and has a resistivity of about 10 k ohms per square. The resistivity can be decreased for longer tracks and/or further sensing conductors may be located along the length of the track (as shown in FIG. 27).

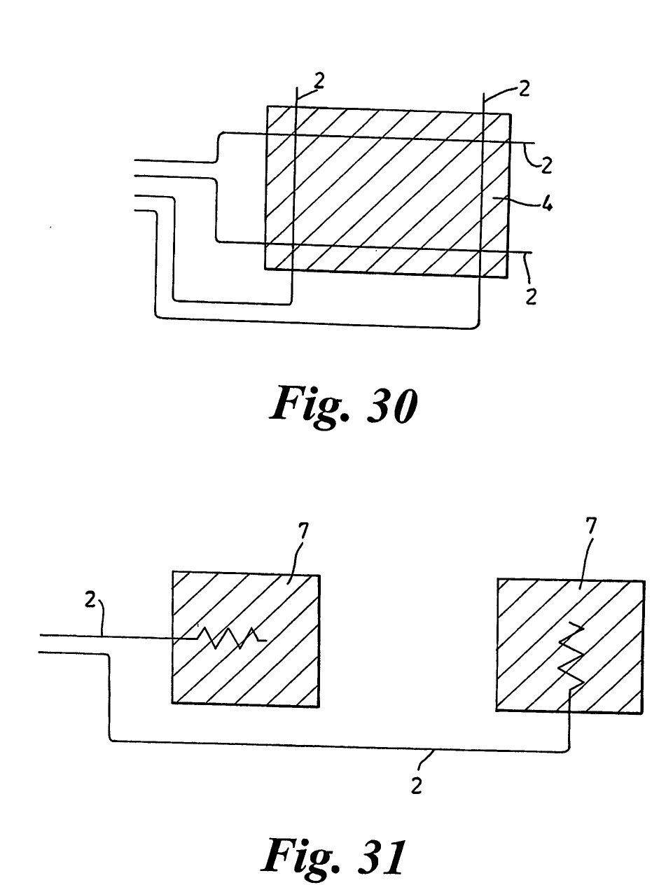

Another application is as a simple input device for a computer, such as a mouse. Preferably, at least three sensing conductors are arranged in a triangle configuration and are capacitively linked by a conductive layer in the form of a conductive film (as shown in FIG. 28). Movement of a user's finger within the proximity of the triangular sensing region, gives rise to interpolated positions referenced to the sensing conductors, which can be supplied to a computer to control the movement of a cursor on a display screen. A more complex mouse, trackerball, or cursor control device, may use further sensing conductors (as illustrated by FIG. 29), including an array of sensing conductors 2 as described in relation to FIG. 1 (as shown in FIG. 30).

It is also possible to combine input device applications into a single device, such that the function of one or more touch sensitive regions may be changed from operation as a mouse, to a keyboard, to a slide switch, a control switch, a digitising tablet etc, under the action of a software controller.

As illustrated in FIG. 31, in keypad applications for instance, the sensing conductors 2 of the touchpad may be arranged so that each conductor relates to a distinct conductive region 7, so that a particular region concentrates the electric field of the related conductor towards the corresponding portion of the membrane, to enhance the touch sensitivity of that conductor.

If the touchpad of the present invention is attached to the case of a portable computing device, such as a laptop computer, the touchpad would make a very effective, rugged and cheap, laptop mouse.

Although the touchpad of the present invention is ideal for detecting the touch or proximity of a finger by altering the immediate capacitive environment of a touch detection system, it will be recognised that the principle can extend to other types of capacitive proximity sensing devices and touch detection systems.

Other embodiments are intentionally within the scope of the appended claims.

1. A touchpad comprising a supporting medium supporting a plurality of spaced apart conductors in which there is no electrical contact between the conductors, each conductor being sensitive to the proximity of a finger to modify the capacitance of said conductor to detect the presence of said finger positioned close to that conductor, the touchpad further comprising a means to concentrate electric field between conductors towards the plane of the supporting medium.

2. The touchpad as claimed in claim 1, wherein the means is an electrically conductive medium proximal to said conductors.

3. The touchpad as claimed in claim 1, wherein the means is adapted to locally modify the capacitative environment between a subset of conductors.

4. The touchpad as claimed in claim 1, wherein the means is adapted to accentuate the variation in capacitance of a conductor and to control the dispersion of a resulting capactive signal propagating from substantially the proximity of said finger.

5. The touchpad as claimed in claim 1, wherein the supporting medium is electrically insulating.

6. The touchpad as claimed in claim 2, wherein the conductive medium is in the form of a conductive layer covering at least a portion of the supporting medium.

7. The touchpad as claimed in claim 6, wherein the conductive layer is discontinuous.

8. The touchpad as claimed in claim 6, wherein the conductive layer is supported by a first surface of the supporting medium or a first surface of a dielectric medium.

9. The touchpad as claimed in claim 8, wherein the dielectric medium has a thickness which is relatively large as compared to the thickness of the conductive layer.

10. The touchpad as claimed in claim 6, further comprising a non-conductive layer proximate to the conductive layer.

11. The touchpad as claimed in claim 8, wherein the supporting medium and conductive layer are separated by the dielectric medium.

12. The touchpad as claimed in claim 8, wherein the conductive layer is sandwiched between the supporting medium and the dielectric medium.

13. The touchpad as claimed in claim 8, wherein the supporting medium is sandwiched between the conductive layer and the dielectric medium.

14. The touchpad as claimed in claim 8, comprising a further conductive layer proximate to the dielectric medium and sandwiching the dielectric medium between the further conductive layer and the conductive layer.

15. The touchpad as claimed in claim 2, wherein the conductive medium has a resistivity in the range of 100 ohms per square to 10,000,000 ohms per square.

16. The touchpad as claimed in claim 2, wherein the conductive medium electrically floats or is grounded to earth.

17. The touchpad as claimed in claim 16, wherein the conductive medium is grounded by a wire or resistor.

18. The touchpad as claimed in claim 6, wherein the conductive layer comprises a plurality of electrically isolated conductive regions separated by regions of the first surface of the supporting medium or first surface of the dielectric medium.

19. The touchpad as claimed in claim 18, wherein the separations between the conductive regions are relatively small compared to the width of the conductive regions, so as to allow capacitive coupling of adjacent regions via the supporting medium or the dielectric medium.

20. The touchpad as claimed in claim 14, wherein the further conductive layer is supported by a second surface of the dielectric medium, the second surface in substantially opposed relation to the first surface of the dielectric medium.

21. The touchpad as claimed in claim 20, wherein the further conductive layer comprises a plurality of electrically isolated conductive regions separated by regions of the second surface of the dielectric medium.

22. The touchpad as claimed in claim 21, wherein the conductive regions on the first surface of the dielectric and the conductive regions on the second surface of the dielectric are registered to each other by virtue of corresponding substantially coterminous areas.

23. The touchpad as claimed in claim 21 wherein the conductive regions on the first surface of the dielectric and the conductive regions on the second surface of the dielectric are registered to each other by virtue of corresponding overlapping non-coterminous areas.

24. The touchpad as claimed in claim 22, wherein the registered regions are capacitively coupled via the dielectric medium.

25. The touchpad as claimed in claim 18, wherein the conductive regions are substantially rectangular.

26. The touchpad as claimed in claim 8, wherein the conductive layer comprises a plurality of electrically isolated conductive regions separated by regions of the first surface of the supporting medium or the first surface of the dielectric medium, each conductive region linked by one or more conductive bridges to adjacent conductive regions, the bridges having a width substantially smaller than the width of the conductive regions.

27. The touchpad as claimed in claim 26, wherein the conductive regions have a relatively large thickness and the conductive bridges have a relatively small thickness to increase the resistance in the conductive layer.

28. The touchpad as claimed in claim 2, wherein the supporting medium and conductive medium are formed as a single conductive support and sensing layer.

29. The touchpad as claimed in claim 28, wherein the single conductive support and sensing layer is formed from a bulk doped medium having a bulk conducitvity.

30. The touchpad as claimed in claim 29, wherein the bulk doped medium is glass or plastic comprising a dopant of conductive material.

31. The touchpad as claimed in claim 30, wherein the conductive material is particulate or fibrous.

32. The touchpad as claimed in claim 31, wherein the particulates may be formed from metal or metal oxides with a size up to 10 microns wide.

33. The touchpad as claimed in claim 31, wherein the fibrous material may be formed from nanotubes or carbon fibers with a length up to 10 millimeters.

34. The touchpad as claimed in claim 28, wherein the plurality of conductors are substantially contained within the single conductive support and sensing layer.

35. The touchpad as claimed in claim 1, wherein the plurality of conductors are each electrically insulated.

36. The touchpad as claimed in claim 35, wherein each conductor is coated with an electrically insulating sheath.

37. The touchpad as claimed in claim 28, wherein the conductive support and sensing layer has a textured surface in the form of surface distortions for the redirection of a point of touch.

38. The touchpad as claimed in claim 1, wherein the touchpad is arranged into a non-planar configuration.

39. The touchpad as claimed in claim 1, wherein the touchpad is resilient.

40. The touchpad as claimed in claim 1, wherein the touchpad is deformable.

41. The touchpad as claimed in claim 2, wherein the conducting medium is Indium Tin Oxide (ITO) or Antimony Tin Oxide (ATO).

42. A touchpad system including a touchpad as claimed in claim 1 including a sensing circuit comprising a touch detector circuit and wake up circuit, the sensing circuit periodically sleeping and waking to measure the state of the touchpad, wherein in response to a touch, the sensing circuit wakes up, if sleeping, and scans the surface to determine the touch position.

43. The touchpad system as claimed in claim 42, wherein the touch is detected in less than about 3 microseconds.

44. The touchpad system as claimed in claim 42, wherein the power consumption of the sensing circuit is less than about 10 microamps when sleeping.

45. The touchpad as claimed in claim 1 wherein the plurality of conductors comprises a first series of spaced-apart conductors and a second series of spaced apart conductors disposed in intersecting relation.
